(19) United States
(12) Patent Application Publication
(10) Pub. No.: US 2010/0233648 A1
(43) Pub. Date: Sep. 16, 2010

(54) ENDODONTIC INSTRUMENT AND METHOD OF MANUFACTURING

(76) Inventors: John McSpadden, Lookout Mountain, GA (US); Mark S. Ferber, Concord, MA (US)

Correspondence Address: LUEDEKA, NEELY & GRAHAM, P.C., P O BOX 1871, KNOXVILLE, TN, 37901, US

(21) Appl. No.: 12/556,255

(22) Filed: Sep. 9, 2009

Related U.S. Application Data
(60) Provisional application No. 61/095,455, filed on Sep. 9, 2008.

(51) Int. Cl. A61C 5/02; B23P 13/00

(52) U.S. Cl. 433/81; 29/896.11; 433/224

(57) ABSTRACT

An endodontic instrument and method for making same is provided. A rod of superelastic material is set into a shaped configuration to form an instrument, such that the instrument may be inserted into a root canal in a configuration different than the shaped configuration and revert towards its shaped configuration during the endodontic procedure.

### CROSS-REFERENCE(S) TO RELATED APPLICATION(S)

This application is a U.S. nonprovisional utility patent application which claims priority to the U.S. provisional application having Ser. No. 61/095,455 entitled “Endodontic Instrument and Method of Manufacturing” to John T. McSpadden and Mark S. Ferber which was filed on Sep. 9, 2008, the contents of which are incorporated herein by reference in their entirety.

### FIELD

This invention relates generally to the field of dentistry and more particularly to endodontic instruments used to safely and efficiently enlarge root canals.

### BACKGROUND OF THE INVENTION

In the field of endodontics, one of the most important and delicate procedures is cleaning or extirpating an elongate, curvilinear, tapered root canal of a tooth to provide a properly dimensioned cavity while essentially maintaining the original central axis and dimensional proportionality of the canal. This step is important in order to enable filling of the canal with as few voids as possible and in a manner that limits the entrapment of any noxious tissue or other undesirable material in the canal as the canal is being filled and avoids deleterious loss of strength in the surrounding tooth structure.

In a root canal procedure, the dentist typically removes inflamed or diseased tissue and material from the canal prior to sterilization and filling of the canal with a permanent, biologically inert filling material. In performing this procedure it is normally critical for the dentist to gain access to the entire canal, shaping it as necessary to help ensure removal of substantially all diseased tissue while retaining the same basic canal shape and axis. However, root canals are very small in diameter, and they are often quite curved with many dimensional irregularities that can frustrate the aim of adequately enlarging the canal in a uniform manner along its length. It is therefore sometimes very difficult to gain access to the full length of the canal for adequate therapy without any detrimental effect.

Many tools have been designed to perform the often difficult task of cleaning and shaping root canals. Historically, dentists have been required to use a multitude of different tools to remove the soft and hard tissues of the root canal. These tools, usually called endodontic files, broaches, reamers, and the like have been made using several different processes. In one process, a file is normally made by twisting a tapered prismatic rod of square, triangular, or other cross sectional configuration in order to provide an elongate tapered file with helical cutting/abrading edges (“K-file”). Another process typically involves grinding helical flutes into a circular or tapered rod to provide an elongate file with one or more helical cutting edges (“Hedstrom file”). Other methods include “hacking” or rapidly striking a circular or tapered rod with a blade at a given angle along the length of the rod, thus providing an endodontic file having a plurality of burr-like barbs or cutting edge projections (“barbed file” or “broach”) and forming notched cutting surfaces along a working portion of a file (“notched file”).

From the materials perspective, endodontic files have generally been made from medical-grade metals, including stainless steels and various machineable alloys. Many steels are inherently too stiff and brittle for facile use as endodontic files. They are prone to breakage in a curvilinear root canal, particularly if over-torqued or over-fatigued. For these and other reasons, many modern endodontic instruments are now made from relatively exotic alloys such as nickel-titanium alloys, including those known as “Nitinol™” or “NiTi.” A series of comparative tests of instruments made of nickel-titanium alloy and stainless steel were said to have been conducted and published in an article entitled “An Initial Investigation of the Bending and the Torsional Properties of Nitinol Root Canal Files,” Journal of Endodontics, Volume 14, No. 7, July 1988, pages 346-351. The tests were said to show that instruments made of nickel and titanium exhibited superior flexibility and torsional properties as compared to stainless steel instruments.

Based on the initial success of these and similar studies, NiTi endodontic instruments have been commercially introduced and have become widely used in the health care industry for extirpating root canals. In general, alloys of nickel (Ni) and titanium (Ti) are said to have a relatively low modulus of elasticity over a relatively wide range, a relatively high yield strength, and the substantially unique property of being a “shape memory alloy” (SMA). SMAs are a unique class of metal alloys that can be made to recover from seemingly permanent strains when they are heated above a certain temperature. SMAs are said to have two stable phases—the high-temperature phase, called austenite, and the low-temperature phase, called martensite. In addition, the martensite can be in one of two forms: twinned and detwinned A phase transformation said to occur between the austenitic and martensitic phases upon heating/cooling is believed to be the basis for the unique properties of the SMAs.

If a mechanical load is applied to SMA material in the state of twinned martensite (at low temperature), it is believed to be possible to detwinn the martensite if the load is sufficient to cause plastic deformation. Upon releasing of the load, the material appears to remain deformed. A subsequent heating of the material to a temperature above the material's austenitic finish temperature reverses the phase transformation (martensite to austenite) and thereby leads to complete shape recovery. Upon cooling in the absence of applied load, the material is believed to transform from austenite into twinned (self-accommodated) martensite. As a result of this phase transformation no observable macroscopic shape change is seen to occur and the SMA material returns to the original shape prior to deformation.

Additionally, SMAs exhibit superelastic behavior during unloading and loading applied above the austenitic finish temperature, optimally just above the austenitic temperature. Superelasticity refers to a highly exaggerated elasticity or spring back. Some SMAs are said to deliver over 15 times the elastic motion of a spring steel, namely, that the alloys can withstand twisting and bending forces over 15 times greater than spring steel without permanent deformation. In view of this superelastic behavior, endodontic instruments are now commonly made using NiTi having an austenitic finish temperature just below the temperature of a human body. Therefore, the instruments will normally exhibit superelastic behavior when used in endodontic procedures performed within the mouth of a patient.

Although the superelastic and shape memory properties of NiTi are believed to be advantageous for endodontic instruments, such properties have been said to cause some difficulties during manufacture of the instruments. For example, if an instrument blank is reshaped to provide cutting surfaces at desired portions of the instrument when the instrument is at a temperature below the austenitic finish temperature, such as at room temperature for some NiTi compositions, the instrument can reportedly revert back to its original shape without cutting surfaces when inserted into the mouth of a patient or otherwise heated above a certain temperature. Attempts have allegedly been made to manufacture NiTi instruments by placing an instrument blank in a furnace or hot salt bath at temperatures of 500° C. or more, removing the heated blank and twisting it to form a K-file type instrument, and then performing subsequent quenching and heat treatment operations to provide an instrument with appropriate physical properties. Such processes are often time consuming and can require substantial tooling, furnaces, and other specialized, expensive equipment. Additionally, the use of heated salt baths and other types of furnaces can be dangerous and can result in unwanted corrosion or other adverse effects on manufacturing tooling and other materials. Accordingly, there is a need for a simpler, quicker, and more cost efficient method for effectively producing endodontic instruments comprising NiTi material or other SMAs.

Another significant drawback to conventional root canal procedures is that a practitioner must generally use a series of endodontic files to clean out and shape a diseased root canal. Typically, this series of instruments consists of a set of files of increasingly larger diameter and, as a result, an increasing taper, as the length of the working portion is often maintained substantially constant. Sets of such files are used to sequentially and gradually enlarge the root canal until the desired shape is achieved. A stepped enlargement in relatively small increments is believed to be an important part of the conventional strategy of avoiding undesirable damage to and other effects on the tooth structure during the enlargement process, and in avoiding imposition of too much torsional load or stress on the material comprising the instrument. In this regard, a set of instruments are often used only once for a particular patient and then discarded, with each instrument in the set provided at substantial individual expense. Accordingly, there is a need for an improved endodontic file design that limits the number of endodontic files necessary to achieve a desired bore shape or degree of enlargement during root canal therapy/filing procedures.

### SUMMARY

It is therefore one object of an embodiment of the present invention to provide an improved endodontic file design and method of manufacturing such files from nickel-titanium alloys and other similar superelastic materials or SMAs, while avoiding many or all of the disadvantages discussed above. Another of the several objects of various embodiments of the invention is to improve the efficacy of an endodontic root canal filling/therapy procedure by, among other things, reducing the number of instruments necessary to enlarge a root canal by use of an instrument which continuously adapts to the walls of a canal as it is being enlarged.

According to one embodiment of the invention, a method for manufacturing an endodontic instrument is provided, the method including the step of heating a portion of a rod to a temperature ranging from about 75° C. to about 175° C., while stressing the rod by contacting the instrument with at least a portion of a first heated surface and at least a portion of a second surface. The first surface includes a first surface structure, the second surface includes a second surface structure, and the first surface structure and the second surface structure substantially coincide. The coinciding physical relationship of the respective surfaces causes the rod to realign along at least part of the coinciding surface structures and the substantially simultaneous application of heat and stress sets the rod in the shaped configuration.

In other embodiments of the invention, various other types of heated tooling may be used. For example, a heated die may contain a shaped blind bore for receiving a portion of the rod. The rod may be inserted into the blind bore, thereby forming the rod into a desired instrument shape while heating the rod to a temperature necessary to set the rod in the desired shape.

According to yet another embodiment of the invention, a novel endodontic instrument is provided. The instrument has a working portion formed from a superelastic alloy which has been set into a shaped configuration. In various embodiments, this shaped configuration is a curvilinear, two dimensional snake-like shape or a three dimensional pigtail shape. When the instrument is inserted into a root canal in a second configuration, preferably a substantially straightened configuration, that is different than the shaped configuration and used in an endodontic procedure, the effective diameter of at least a section of the working portion increases and the effective length of at least a section of the working portion decreases as the endodontic procedure continues to progressively remove more material from an enlarging canal.

For purposes of summarizing certain embodiments of the invention and the advantages achieved over the prior art, certain objects and advantages of certain embodiments of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a partially schematic view an apparatus used in an embodiment of a method for manufacturing an endodontic instrument, wherein the rod 18 includes surface hatching to generically indicate that there are cutting surfaces thereon;

FIG. 2 depicts a stepwise diagram describing a method for manufacturing an endodontic instrument;

FIG. 3 illustrates a particular step in an embodiment of a method for manufacturing an endodontic instrument, wherein the rod includes surface hatching to generically indicate that there are cutting surfaces thereon;

FIG. 4 shows a partially schematic view of an embodiment of a working portion of an endodontic instrument;

FIG. 5 shows a partially schematic view of an apparatus used in an embodiment of a method for manufacturing an endodontic instrument, wherein the rod 18 includes surface hatching to generically indicate that there are cutting surfaces thereon;

FIG. 6 illustrates a particular step in an embodiment of a method for manufacturing an endodontic instrument, wherein the rod 18 includes surface hatching to generically indicate that there are cutting surfaces thereon;

FIG. 7 depicts a stepwise diagram describing a method for manufacturing an endodontic instrument, wherein the shaft 37 includes surface hatching to generically indicate that there are cutting surfaces thereon;

FIG. 8 illustrates an embodiment of an endodontic instrument as it may be used in dental practice;

FIG. 9 shows an embodiment of a working portion of an endodontic instrument wherein the shaft includes surface hatching to generically indicate that there are cutting surfaces thereon;

FIG. 10 shows a die for use in an embodiment of manufacturing an endodontic instrument;

FIG. 11A shows a side view of another embodiment of a section of a working portion of an endodontic instrument;

FIG. 11B shows an angled view from a distal end of a section of the working portion of an endodontic instrument shown in FIG. 11A; and

FIG. 11C shows an angled view from a proximal end of a section of the working portion of an endodontic instrument shown in FIG. 11A.

### DETAILED DESCRIPTION

An embodiment of the invention described herein includes a method for forming endodontic files by treating an elongate rod formed from a generally predetermined length of superelastic material by the substantially simultaneous application of appropriate heat and stress. In one embodiment, the rod 18 prior to treatment is tapered, substantially cylindrical, and fluteless. Alternatively, the rod may be nontapered and/or the rod may have various shapes, such as having a cross section that is triangular, rectangular, hexagonal, star-shaped, frusto-cylindrical, asymmetrical polygonal, diamond, or other various shaped cross-sections. In other embodiments, the rod may be fluted, such as having the helical shape of traditional endodontic instruments.

The rod 18 is also preferably formed from a nickel titanium alloy, such as SE508 nickel-titanium wire manufactured by Nitinol Devices and Components, Inc. of Fremont, California. This is a typical binary nickel-titanium alloy used for endodontic files and comprises about 56% nickel and about 44% titanium by weight. The rod 18 may also be formed from other NiTi compositions or other superelastic materials.

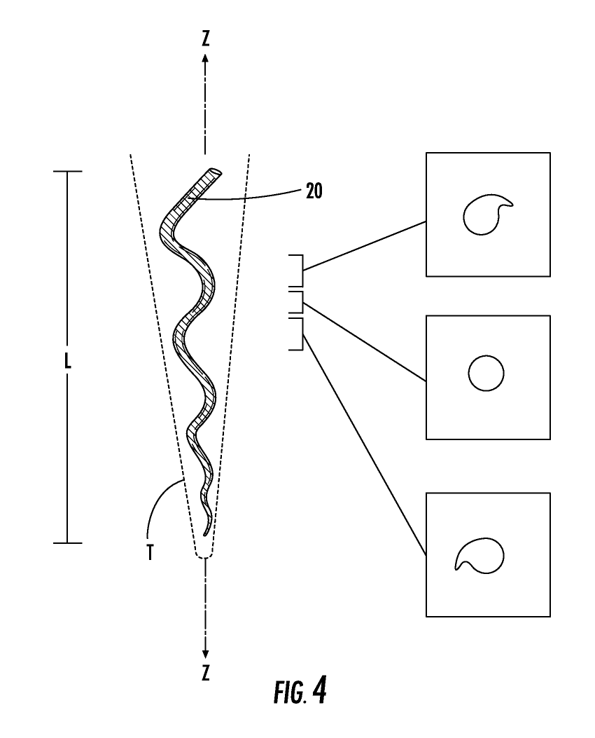

The rod preferably includes cutting surfaces along a working portion. The cutting surfaces may be notched cutting surfaces, such as those disclosed in U.S. Pat. No. 7,223,100 to Brock et al., which is incorporated herein by reference. The cutting surfaces may be helical cutting surface such as those in traditional helical endodontic instruments, or other cutting surfaces known in the art. Alternately, the cutting surfaces could be angled comers extending along a portion of the length of a polygonal, fluteless rod. In certain embodiments, the cutting surfaces alternate or are selectively patterned based on the specific curved profile of the endodontic instruments described herein. An example of such alternating pattern is shown in FIG. 4.

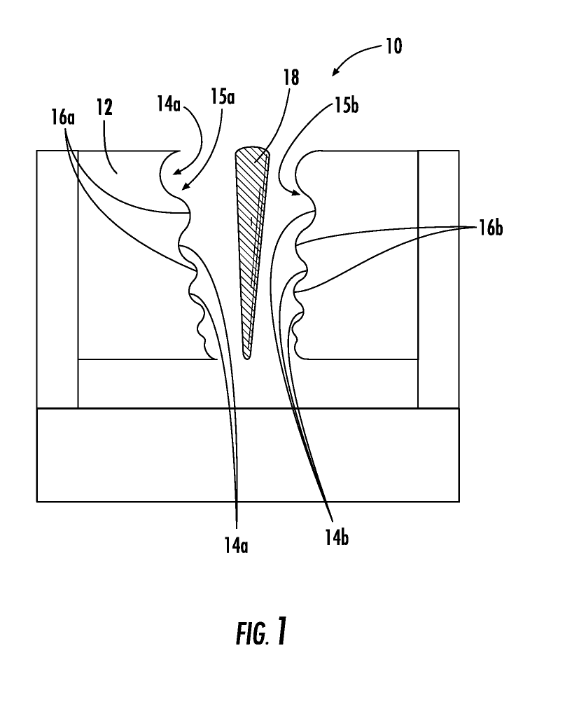

In a preferred method of manufacturing instruments, heated tooling is used to morph at least a portion of the rod 18 into a desired instrument shape while substantially simultaneously setting the rod in the desired shape by the application of heat and load to the rod. In one embodiment shown in FIG. 1, the heated tooling 10 may include a forming iron-type device 12. The forming iron 12 preferably includes a first heated forming surface 15A and a second heated forming surface 15B, although in alternate embodiments only one of the forming surfaces 15 is heated. In one embodiment, the heated forming surfaces 15A and 15B include a plurality of ripples. The crests of the ripples 16A along heated forming surface 15A preferably correspond to troughs 14B of ripples 16B along heated forming surface 15B, and the crest of ripples 16B correspond to troughs 14A, as shown in FIG. 1. In alternate embodiments, the heated forming surfaces 15 may have various other corresponding surface features to provide a desired instrument shape to rod 18.

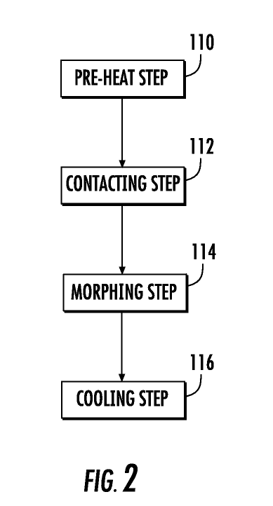

In order to form the rod into a desired instrument shape, rod 18 is compressed between the heated forming surfaces 15 causing a stress on the rod preferably ranging from about 550 MPa to about 1500 MPa, more preferably about 1250 MPa. The method, shown stepwise in FIG. 2, may include a preheating step 110 wherein the heated forming surfaces 15 are heated prior to forming the instrument. A contacting step 112 may then be performed including contacting a rod 18 with at least a portion of the heated forming surfaces 15 while the rod 18 is held between the surfaces. The step is preferably performed by moving one of the heated forming surfaces 15 towards the other, or moving both forming surfaces 15 towards each other, such that the rod 18 is compressed therebetween, thereby changing the shape of the rod 18.

A morphing step 114 includes maintaining contact between the heating surface 14 and the rod 18 for a sufficient duration to bring the temperature of the rod 18 to a temperature preferably ranging from about 75° C. to about 175° C. for a rod formed of SE508 NiTi material, more preferably about 150° C., such that the rod is set into the desired shape by superelastic material flow under applied load (stress) and temperature. The heating surface 14 is preferably maintained at or brought to a temperature ranging from about 100° C. to about 200° C. during the contacting and morphing steps. In such an embodiment, the heated forming surfaces remain in contact with the rod 18 for about 10 to 20 seconds during the morphing step. However, in certain embodiments, especially when using tooling at a higher temperature, the heated forming surfaces may remain in contact for a smaller period of time which can be as low as about 0.5 seconds.

After the morphing step 114, the rod 18 is then separated from the heated surfaces 15 and is cooled during a cooling step 116. The cooling is preferably performed by bench cooling, although other methods of cooling may be used, such as rapidly quenching the rod.

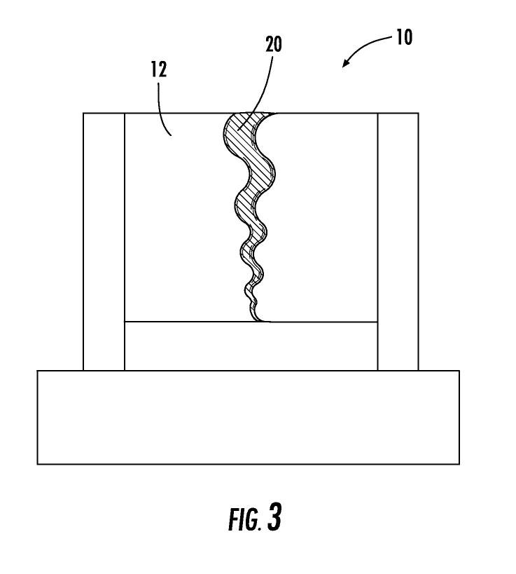

FIG. 3 shows the relative position of the rod 18 and the forming iron 12 during step 112 and step 114. The contact between the heated forming surfaces 15 and the rod 18 in morphing step 114 causes the rod 18 to reshape and change physical characteristics such that the rod 18 is set into the desired shape. In the embodiment shown in FIG. 3, during the morphing step 114, the rod 18 morphs into a substantially snake-like sinusoidal shape, as explained in further detail below.

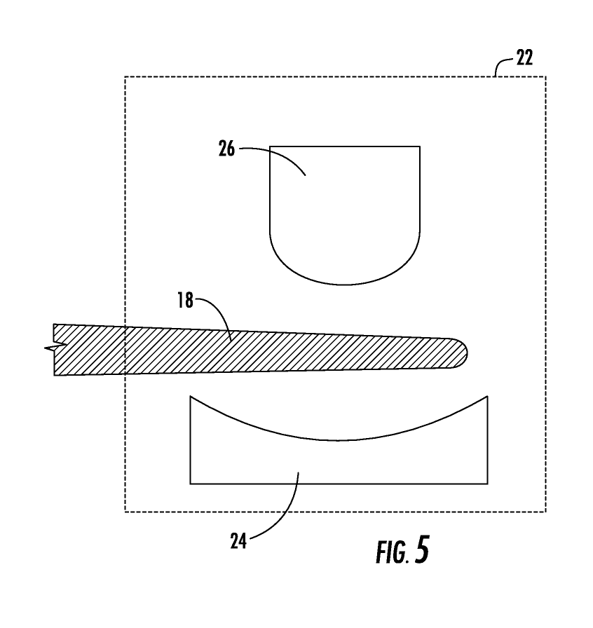

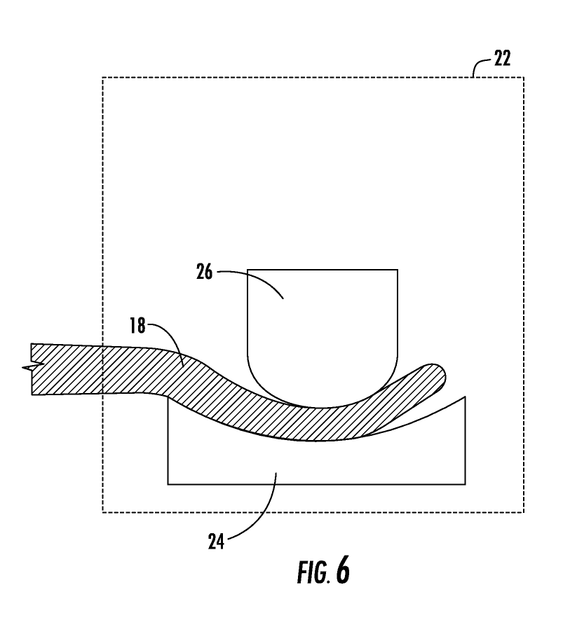

FIG. 5 shows another example of heated tooling for use in manufacturing endodontic instruments according to an embodiment of the invention. In this embodiment, a heated forming apparatus 22 is used to set a rod formed from a predetermined length of superelastic material in a desired instrument shape. The forming apparatus 22 includes a form base 24 and a wedge 26. A rod 18 is advanced between the form base 24 and the wedge 26. The wedge 26 is moved such that a portion of the rod 18 between the wedge 26 and the form base 24 is forced to conform to a new shape, as shown in FIG. 6, under an applied load preferably ranging from about 550 MPa to about 1500 MPa, more preferably about 1250 MPa. Alternatively, the form base 24 may be moved toward the wedge 26, or both the wedge 26 and the form base 24 may be moved toward one another to accomplish this task. In one embodiment, the wedge 26 and/or the form base 24 are heated to a temperature prior to interaction with the rod 18 such that the rod 18 attains a temperature preferably ranging from about 75° C. to about 175° C., more preferably about 150° C., and in other embodiments, the wedge and/or form base may be heated substantially simultaneously contacting the rod. In various embodiments, both the form base and wedge are heated and, in other embodiments, only one of the form base or wedge may be heated.

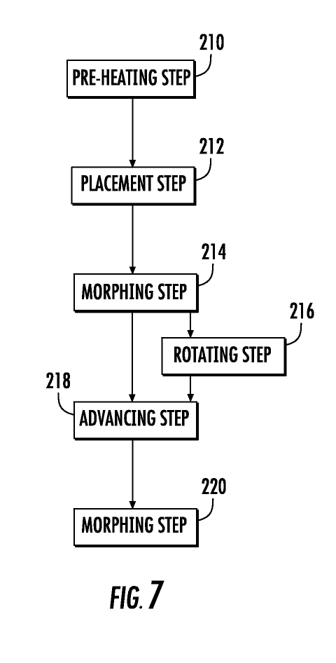

The steps of the method are shown in FIG. 7 and, in one embodiment, include a preheating step 210 for preheating the form base 24 and/or the wedge 26 followed by a placement step 212 of placing a first portion of the rod 18 between the wedge 26 and the form base 24. A morphing step 214 includes bringing the wedge 26, the rod 18, and the form base 24 into contact with one another so that a portion of the rod 18 is forced into a new desired shape while the rod 18 is heated to a sufficient temperature to set the rod 18 in the desired shape. An advancing step 218 includes advancing the rod such that a second portion of the rod 18 is placed between the wedge 26 and the form base 24. A second morphing step 220 may follow, and the process may continue until the rod 18 has been transformed to a new desired shape (i.e., a rippled snake-like shape).

Additionally, in a preferred embodiment, at least one rotation step 216 is added after morphing step 214. During the rotation step, the rod 18 may be rotated 180° between morphing steps to provide a two dimensional rippled, substantially snake-like sinusoidal shape. In other embodiments, the rotating step 216 may include a 90° rotation or other angles of rotation to form various three-dimensional shapes, such as a substantially spiral, pig-tail shape, or other variously shaped instruments.

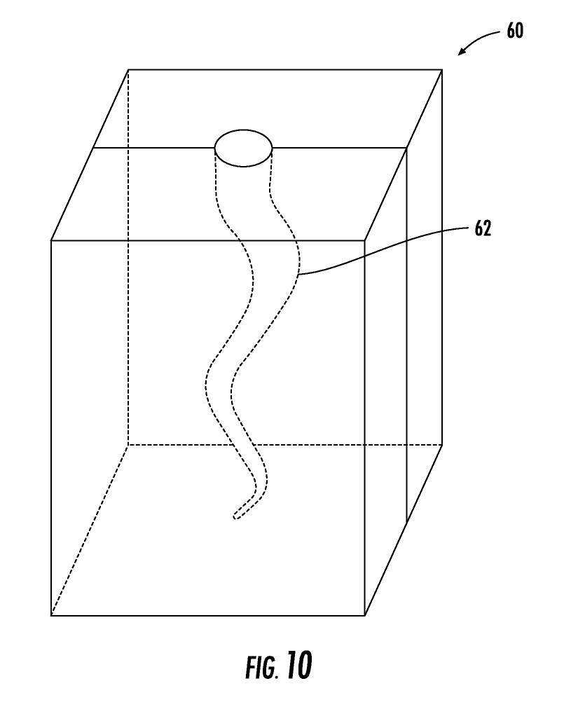

In an additional embodiment of the invention, such as shown in FIG. 10, a heated die 60 may be used to set a desired shape to a rod 18. A shaped blind bore 62 extends through a portion of the interior of the die 60. The shaped bore preferably has a diameter slightly larger than the diameter of a rod 18 and has a shape substantially the same as the shape desired to be imparted to the rod 18 to form an endodontic instrument. In this embodiment of the invention, a rod 18 may be threaded into the shaped bore 18, wherein it is held in the desired instrument shape and heated to a temperature sufficient to set the rod in the desired instrument shape. After the rod 18 has been sufficiently heated, the rod 18 may be cooled within the die 60 or removed from the die to cool. The die may be formed of two or more portions which separate to allow the instrument to be easily removed from the interior of the die 60. However, in alternate embodiments, the rod 18 may be removed by threading out of the die 60 after cooling.

In various other embodiments of making an endodontic instrument according to the present invention, other types of heated tooling may be used. Additionally, in a preferred embodiment, multiple endodontic instruments may be formed substantially simultaneously by placing multiple rods in the heated tooling simultaneously to set the rods in the desired instrument shape. The use of heated tooling according to the preferred embodiment of the present invention applies stress to a rod while forcing it into a desired instrument shape and substantially simultaneously heating the rod such that the instrument remains in the desired shape and does not return to its prior shape when subsequently heated above its austenitic finish temperature. The methods of the present invention allow for an economic, safer, quicker, and simpler method of creating endodontic instruments, as compared to the use of high temperature furnaces or heated salt baths and numerous quenching and heat treatment operations.

In additional embodiments of the above described method, the pre-heating steps 110/210 include heating the rod 18 by other sources prior to the contacting step 214. Alternately, in certain embodiments of the method described herein, the rod 18 may be partially pre-heated prior to contact with the heated tooling. Then, the heated rod 18 is placed in the heated tooling 10 as shown in FIG. 1 and the tooling 10 is used to force the heated rod 18 into a new shape (e.g., the shape shown in FIG. 3). In certain embodiments wherein the rod 18 is entirely pre-heated to the necessary temperature, forming tooling may be unheated. In further embodiments, the rod may be heated by the tooling using various alternate heating methods, such as resistance heating.

The method described above may be used to form endodontic instruments into unique, novel shaped configurations. For example, in one preferred embodiment, the instrument may be set into a rippled sinusoidal shape or other two dimensional shapes. In yet another preferred embodiment, an instrument may be provided with a three dimensional shape, such as a spiral, pigtail-like shape, i.e. as if the rod had been wrapped around an elongate cylinder or cone while also extending from one end to the other end of the elongate cylinder/cone, or other three dimensional shapes.

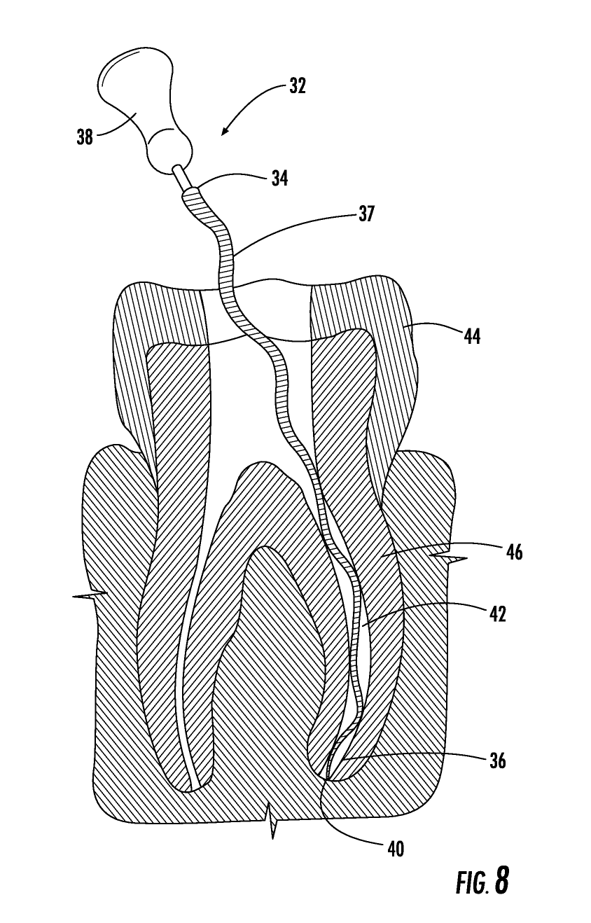

In a preferred embodiment of a two-dimensionally sinusoidal shaped configuration of an instrument, as shown in FIGS. 4 and 8, a shaped working portion 20 with cutting surfaces for removing tissue from a root canal is disposed on the shaft 37 of an endodontic file 32. In one embodiment, the working portion 20 extends from a proximal end 34 to a distal end or tip 36 of the shaft 37. However, in alternate embodiments, only a portion of the shaft 37 has cutting surfaces thereon. A standard dental handle 38 or other manipulating device is preferably fitted to the proximal end 34 of the shaft by fitting methods and associated structures (if any) known to those skilled in the art. The tip 40 of the shaft 20 may assume any number of a variety of possible configurations known to those skilled in the art (e.g., chisel, cone, bullet, multi-faceted and/or the like).

The working portion 20 in its “shaped configuration” is preferably effectively tapered as shown by dotted lines “T” in FIG. 4. The effective tapering of the working portion 20 preferably corresponds to the tapering of a wider endodontic file as used in the final stage or stages of a root canal procedure and the actual tapering of the rod (i.e. the taper of the rod before setting into the shaped configuration) preferably corresponds to the tapering of a narrower endodontic file typically used in earlier stages. The effective tapering may be constant or varied along the length of the working portion 20. In alternate embodiments of the invention, the effective tapering may be substantially nontapered but the instrument may have an effective diameter along at least a portion of the instrument corresponding to the diameter of a typical wide file used in later stages of a root canal procedure. The effective taper of the working portion 20 may be a result of a combination of both the tapering of the rod 18 (if any) present prior to the shaping by heat/stress treatment and tapering imparted to the working portion by the heating/stressing process.

As explained further below, the working portion of the nickel titanium endodontic file 32 set in a two dimensionally rippled shaped configuration has the advantageous characteristic that it will expand laterally while in use during the progression of a root canal procedure. In one embodiment of the invention, the actual width of the rod 18 and associated tapering—in contrast to the effective width and effective tapering of the working portion 20 in its shaped configuration—substantially corresponds to the width and/or tapering of a narrow endodontic file used early in a root canal procedure. When an endodontic file as described herein is used in an endodontic procedure, the flexibility of the working portion 20 allows it to be stretched from its shaped configuration into a more rod-like, substantially straight configuration. This straightening may be performed by the endodontist substantially simultaneously with insertion of the working portion 20 into a canal or even prior to use in a root canal procedure. In some embodiments, the straightened configuration may not be entirely straight, but instead may be a configuration wherein the effective diameter of the working portion is less than the effective diameter of the working portion in its shaped configuration.

The straightened configuration allows at least a portion of the working portion 20 to be easily inserted into the narrow root canal area 42 of a tooth 44 at the beginning stages of root canal boring. After insertion of the rippled extension into the root canal, the endodontic file 32 may be used by an endodontist in a similar manner to a typical endodontic file, such as by rotating and/or longitudinally reciprocating the instrument within the canal. As the instrument is rotated and/or reciprocated, the cutting surfaces on the working portion 20 displace internal tooth material 46 from the root canal 42.

When the endodontic file 32 is within the root canal, the temperature of the file 32 is preferably above its austenitic finish temperature due, at least in part, to the body temperature of the patient. Accordingly, the file 32 exhibits superelastic characteristics and exhibits internal forces as the file 32 attempts to return to its shaped configuration from the straightened configuration. The working portion 20 behaves as if it has a “memory” as it attempts to bring the working portion 20 substatitially back to its shaped configuration.

During the root canal procedure, as the internal tooth material 46 is removed from the root canal walls and extirpated from the root canal, the size of the root canal increases and, correspondingly, the free space for rotation of the working portion 20 within the root canal 42 increases. As the free space increases, the biased working portion 20 contracts longitudinally and expands laterally towards its shaped configuration within the root canal. As the effective diameter of the working portion 20 expands laterally, the cutting edges on the outside edges of the working portion continually remove material from the walls of the root canal, thereby continually expanding the canal. In a preferred embodiment, the working portion 20 substantially conforms towards its former shaped configuration, allowing the working portion 20 to displace more tooth material 46 and thereby creating an ever-expanding tapered void within the root canal until the working portions substantially reaches its shaped configuration.

The effective width and tapering of the working portion 20 at or approaching the shaped configuration preferably corresponds to the width and/or tapering of a wide endodontic file used late in a root canal boring process. Accordingly, the file 32 may be inserted into a narrow canal at the beginning of the boring process, but increase in effective width during use such that the canal reaches a desired diameter. Thus, the endodontic file 32 according to the preferred embodiments discussed above is effective in limiting the amount of files needed in a typical root canal procedure. In some embodiments, it may be possible to use a single endodontic file 32 to perform a root canal procedure, rather than a set of files of varying sizes as is typically used.

Additionally, the endodontic file 32 of various embodiments of the present invention is more flexible than typical instruments for use at late stages of an endodontic procedure with actual diameters similar in dimension to the effective diameter of the working portion of the endodontic file 32. Such larger diameter instruments are needed in typical endodontic procedures in order to provide the canal with the proper diameter. However, due to stiffness created by their larger diameter, the instruments can face problems in effectively navigating the curves of a canal, often resulting in the instrument boring into the side wall of a canal or creating a canal without a uniform diameter, or failure of the instrument due to fatigue. The present endodontic file 32 has an actual diameter similar to narrower typical instruments and similar flexibility, and can therefore more effectively navigate a curved canal and avoids fatigue issues which tend to be more prevalent in larger diameter instruments, while also having an effective diameter which allows the canal to be formed with the proper diameter.

Further, embodiments of the invention allow for better extirpation of a canal than typical instruments. Material removed from the walls of a canal has a tendency to become clogged within the canal and/or helical flutes of a typical endodontic instrument rather than being effectively extirpated from the canal. This is at least partly due to the lack of sufficient free space in the canal because the diameter of the canal is substantially the same as the diameter of the instrument. However, while the effective diameter of the working portion of the present endodontic file 32 is substantially the same as the diameter of the canal, the actual diameter of the rod 18 forming the working portion can be substantially smaller than the diameter of the canal, resulting in sufficient free space within the canal such that extirpation of debris may be more effectively accomplished.

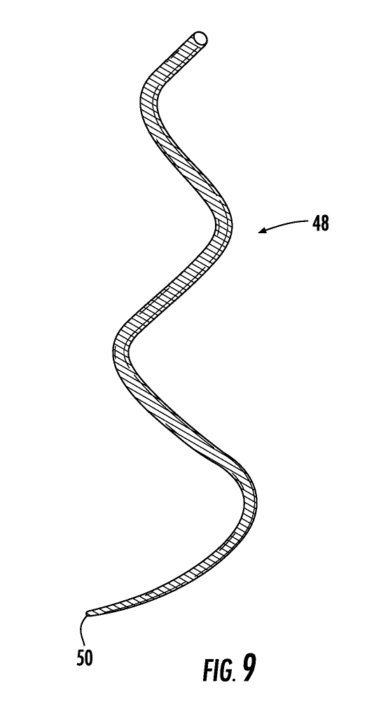

In alternate embodiments of the instrument of the present invention, the working portion 48 has a reverse effective taper as shown in FIG. 9. One purpose of the reverse effective taper of the working portion 48 is at least in part due to thinner rod size due to rod tapering towards the distal end of the shaft. The smaller diameter adjacent the distal ends yield less contact force within a root canal as the working portion attempts to return to its shaped configuration than the portion of the rod with the larger diameter adjacent the proximal end. Thus, as the thickness of the working portion 48 decreases towards the distal end, the cutting force between the working portion and a tooth also decreases. To combat this trend, in this embodiment, the working portion 48 is effectively tapered more widely toward its thinner end as shown in FIG. 9. Because of the tendency of the working portion 48 to substantially conform to its tapered shape, the increased exertion of force from the thinner end 50 of the working portion 48 due to the memory effect helps to counterbalance the decrease in force due to the thinner actual diameter at the thinner distal end 50 of the working portion 48.

In other preferred embodiments, endodontic files may have working portions of various three-dimensionally shaped configurations, such as a spiral, substantially pigtail-shaped working portion or other various three dimensionally shaped configurations of working portions which expand laterally during use in a root canal procedure. As with the two dimensionally rippled sinusoidal working portions described above, such three-dimensionally shaped working portions may be substantially straightened to fit into a root canal at the early steps of the performance of any endodontic procedures, while having the ability to increase the size of the root canal substantially to a final desired diameter, thereby decreasing the number of endodontic instruments required to perform endodontic procedures.

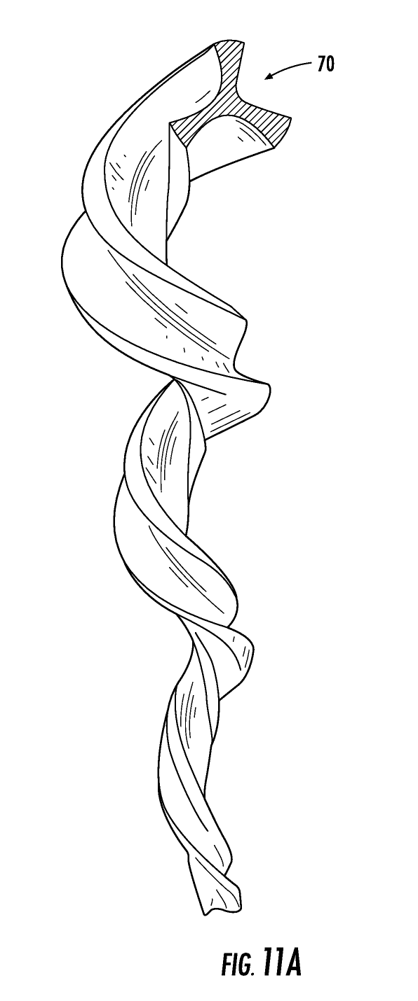

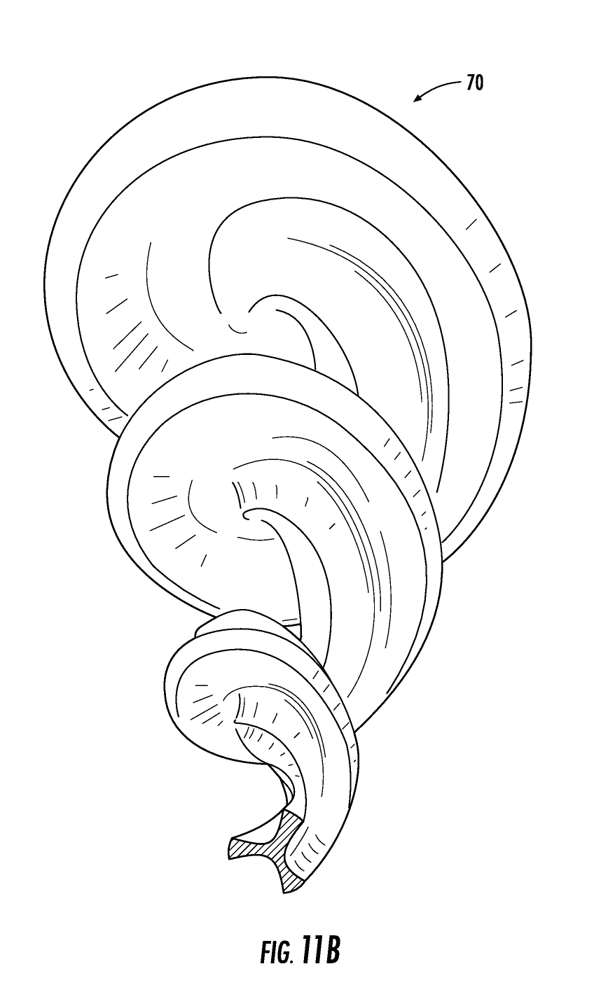

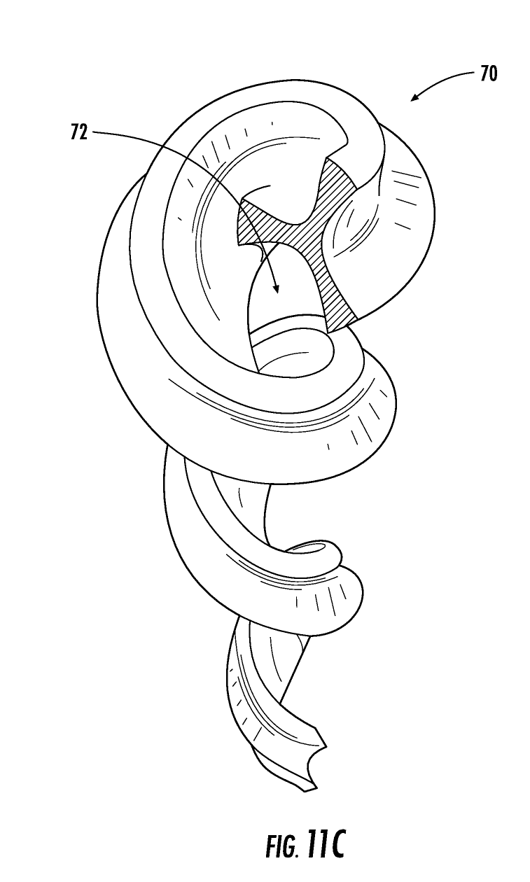

An example of such an instrument 70 is shown in FIGS. 11A-11C. Such three-dimensionally shaped instruments have a spiral, pigtail-like shape, i.e. as if the rod had been wrapped around an elongate cylinder or cone while also extending from one end to the other end of the elongate cylinder/cone. The curvilinear spiral shaped configuration may be a substantially smooth, circular spiral, but in alternate embodiments may have various polygonal shapes. Such polygon spiraled curvilinear configurations may be especially found when set in the shaped configuration by heated wedge tooling discussed above or similar types of tooling, in view of the tendency of certain types of tooling to form angled bends rather than smooth curves during formation of the shaped configuration. The number of spirals per inch on the working portion of the instrument may be uniform from a proximal end to a distal end of the working portion. However, in various embodiments, the pitch of the instrument may increase from one end to the other.

In addition to the improved characteristics of the above described two dimensionally shaped instruments, certain three dimensionally shaped instruments have other enhanced features which may be preferable in certain endodontic procedures. For example, the overall spiral shape of the instrument 70 as it returns towards its shaped configuration assists in the extirpation of debris from the canal. As the instrument is rotated within the canal, the spiral configuration spins debris out from the canal. Also, a greater portion of the three-dimensionally shaped working portion remains in contact with the walls of the canal as the instruments returns towards its shaped configuration, in comparison to the two-dimensionally shaped instrument, thereby potentially providing more efficient cutting of the root canal wall.

Further, a center portion 72 of the spiral three-dimensionally shaped instrument may be used for irrigation purposes during an endodontic procedure. Fluid, such as water, may be pumped into the center portion of an instrument to assist with extirpation of material from the canal. Such fluid preferably travels down the center portion 72 of the instrument towards a distal end of the working portion and is subsequently spun out of the canal by the spiral shaped instrument, thereby carrying debris out of the canal.

Various advantages are provided by the various embodiments of endodontic files described herein including (1) an improved ability to remove internal tooth material along uneven surfaces within a tooth, (2) increased flexibility because of the relatively thin diameter of the working portion rod in comparison to the diameter of working portions of endodontic instruments traditionally used in later stages of endodontic procedures, (3) decreased metal fatigue within the endodontic instrument because of the relatively thin diameter of the rippled extensions, and (4) a decreased number of endodontic files needed to perform endodontic procedures.

The concepts and teachings of the present invention are particularly applicable to nickel-titanium alloys and endodontic instruments fabricated therefrom. However, the invention disclosed herein is not limited specifically to endodontic instruments fabricated from NiTi alloys, but may be practiced with a variety of dental instruments using any one of a number of other suitable superelastic alloys.

Additionally, although the above description has focused on endodontic files with cutting surfaces on a working portion, the concepts of the present invention are applicable to other endodontic instruments, such as reamers, obturators, drill bits, compactors, and the like. For example, the present invention could be particularly useful with endodontic compactors to account for variances in the root canals taper and/or shape, thereby more effectively inserting filling material, such as gutta percha, into a root canal.

Further, various embodiments of the endodontic instruments broadly described above are formed from substantially solid rods. However, in alternate embodiments, the working portion of the instrument and/or other portions of the instrument may be substantially tubular with openings extending from the exterior of portions of the tubular rod to the interior, hollow center of the tubular rod. Water or other fluids may be pumped through the hollow tube such that it flows out from the openings in order to irrigate the canal during endodontic procedures.

Additionally, although instruments according to the present invention have been described as being preferably manufactured using heated tooling, instruments according to embodiments of the invention may also be produced by other methods, such as forming the instrument and then separately placing the instrument into a furnace.

Although embodiments of the invention have been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

What is claimed is:

1. A method for manufacturing an endodontic instrument comprising the steps of heating a working portion of an elongate, substantially linear rod formed of a superelastic material and having cutting surfaces thereon to a temperature ranging from about 75° C. to about 175° C., and placing the working portion between at least a portion of a first heated surface and at least a portion of a second surface and shape stressing the working portion at a stress ranging from about 550 MPa to about 1500 MPa, wherein the first surface includes a first surface structure, wherein the second surface includes a second surface structure, and wherein the first surface structure and the second surface structure substantially coincide, thereby causing the working portion to realign along at least part of the coinciding surface structures, such that the applied heat and stress cause the portion of the superelastic rod to set into a shaped, curvilinear configuration.

2. The method of claim 1, wherein the working portion of the endodontic instrument is heated substantially simultaneously with shape stressing by placement of the rod between the coinciding surfaces of the first heated surface and second surface.

3. The method of claim 1, wherein the second surface is also a heated surface.

4. A method for manufacturing an endodontic instrument comprising the steps of:
a. placing at least a first portion of an elongate, substantially linear rod formed of a superelastic material and having cutting surfaces thereon into a morphing apparatus, wherein the morphing apparatus includes heated tooling; and
b. shaping the first portion into a desired predetermined curvilinear shaped configuration with the heated tooling; and
c. heating the first portion under an applied load from the heated tooling such that the rod section is set in the shaped configuration.

5. The method of claim 4, wherein the heated tooling comprises a heated die with a shaped blind bore extending through a portion of the interior of the die for receiving the first portion of the rod, the shaped blind bore having a shape substantially similar to the desired curvilinear shaped configuration, and further wherein the working portion is set into the shaped configuration by threading the rod into the blind bore such that the portion of the rod is heated by the die while the portion is maintained in the shaped configuration within the blind bore.

6. The method of claim 4 further comprising the steps of:
d. rotating and advancing the rod such that a second portion of the rod is placed into the heated tooling;
e. shaping the second portion into a curvilinear shaped configuration with the heated tooling; and
f. heating the second portion under an applied load with the heated tooling such that the second portion is set in the desired instrument shape.

7. The method of claim 4, wherein the first portion is heated by the heated tooling to a temperature ranging from about 75° C. to about 175° C.

8. The method of claim 4, wherein the first portion is heated by the heated tooling to a temperature of about 150° C.

9. The method of claim 4, wherein the first potion is stressed by the heated tooling under an applied load ranging from about 550 MPa to about 1500 MPa.

10. The method of claim 4, wherein the first potion is stressed by the heated tooling under an applied load of about 1250 MPa.

11. An endodontic instrument formed from an elongate rod of superelastic material comprising a working portion with cutting surfaces thereon, wherein the working portion has a curvilinear shaped configuration, such that when the instrument is inserted into a root canal in a second substantially straightened configuration and cutting surfaces are used to extirpate a root canal during an endodontic procedure, the effective length of at least a section of the working portion decreases and the effective diameter of at least a section of the working portion increases to adapt to walls of a root canal as the root canal is enlarged as the endodontic procedure progresses.

12. The endodontic instrument of claim 11, wherein the superelastic material comprises a nickel-titanium alloy which has been shaped and set into the curvilinear shaped configuration by simultaneous application of heat and stress.

13. The endodontic instrument of claim 11, wherein the curvilinear shaped configuration is a two dimensional substantially sinuoidal configuration.

14. The endodontic instrument of claim 11, wherein the curvilinear shaped configuration is a substantially spiral pigtail shaped configuration.

15. The endodontic instrument of claim 11, wherein the working portion in the curvilinear shaped configuration has an effective taper greater than the actual taper of the rod.

16. The endodontic instrument of claim 11, wherein the working portion in the curvilinear shaped configuration has an effective diameter greater than the actual diameter of the rod.

17. An endodontic instrument formed from a rod of superelastic material comprising a working portion with cutting surfaces thereon for extirpating a root canal, wherein the working portion extends from its proximal end to its distal end in a substantially spiral, pigtail-shaped configuration, such that when the instrument is inserted into a root canal in a substantially straightened configuration and the cutting surfaces are used to remove material from the walls of the root canal, the effective width of at least a section of the working portion expands to adapt to the walls of a root canal as the canal is enlarged as the endodontic procedure progresses, thereby substantially continuously enlarging the root canal until the working portion substantially returns to its curvilinear shaped configuration.

18. A method of using the endodontic instrument of claim 14 comprising pumping fluid into a center portion of the instrument during an endodontic procedure, whereby the fluid irrigates the root canal and carries debris out of the canal as the instrument is rotated in the canal.

19. A method for using an endodontic instrument formed from a superelastic material, the instrument comprising a working portion in a shaped curvilinear configuration and having cutting surfaces thereon for extirpating a root canal, comprising the following steps:
a. straightening the working portion of the instrument from a shaped curvilinear configuration into a substantially straightened configuration;
b. inserting the working portion of the instrument into a root canal; and
c. rotating or reciprocating the instrument within the root canal to perform an endodontic procedure wherein the effective diameter of at least a section of the working portion increases as the working portion reverts towards the shaped curvilinear configuration to adapt to the walls of the root canal as the canal is enlarged as the endodontic procedure progresses.

20. The method of claim 19, wherein the working portion is straightened substantially simultaneously with insertion of the working portion into the root canal.
